(19) United States
(12) Patent Application Publication
(10) Pub. No.: US 2024/0199416 A1
(43) Pub. Date: Jun. 20, 2024

(54) DEVICE FOR CONTROLLED PRODUCTION OF A GAS FROM TWO FLUID REAGENTS DEPOSITED ON A SURFACE

(71) Applicant: HYSILABS, SAS, Aix-en-Provence (FR)

(72) Inventors: César Arturo MASSE DE LA HUERTA, Mexico City (MX); Alexandre NATT, Hésingue (FR); Vincent LOME, Marseille (FR)

(21) Appl. No.: 18/555,361

(22) PCT Filed: Apr. 13, 2022
(86) PCT No.: PCT/EP2022/059842

§ 371 Date: Oct. 13, 2023

(30) Foreign Application Priority Data
Apr. 13, 2021 (EP) 21168116.8

(51) Int. Cl. C01B 3/06; B01J 14/00; B01J 19/06; B01J 19/18; B01J 19/26; C01B 3/32

(52) U.S. Cl. CPC C01B 3/06; B01J 14/00; B01J 19/06; B01J 19/18; B01J 19/26; C01B 3/32; C01B 2203/02

(57) ABSTRACT

A device is provided for controlled production of a gas from first and second liquid reagents that, when mixed, produce the gas and a non-gaseous byproduct, the device comprising a reactor surface having a substantially vertical revolution axis; a shaft centered on the revolution axis and rotating relative to the reactor surface; two nozzles attached to the shaft, configured to spray the first and second reagents respectively on the reactor surface, wherein the two nozzles are tilted toward each other so that the first and second reagents are sprayed with intersecting cones on a common area of the reactor surface; and a scraper attached to the shaft, configured to separate the byproduct from the reactor surface while following the nozzles at a distance sufficient to let the reagents react.

### CROSS-REFERENCE TO RELATED APPLICATIONS

This application is a 371 National Stage of International Application No. PCT/EP2022/059842, filed Apr. 13, 2022, which claims priority to European Patent Application No. 21168116.8 filed Apr. 13, 2021, the disclosures of which are herein incorporated by reference in their entirety.

### TECHNICAL FIELD

The present invention relates to hydrogen carrier compounds, and more specifically to collecting the production of hydrogen from a liquid hydrogen carrier. The production system may be applied more generally to any gas generated by mixing liquid reagents leaving a solid byproduct.

### BACKGROUND

Hydrogen carrier compounds can convey large amounts of hydrogen in solid or liquid form, which facilitates the transport of hydrogen. Such hydrogen carriers may be of the family of silylated derivatives, more specifically of hydrogen-polysiloxanes, having the general formula (HRSiO)n. In order to extract the hydrogen, the hydrogen carrier compound is mixed with a so-called proton source, often water, in the presence of catalysts—see for instance patent applications WO2010094785 and WO2011098614. After the hydrogen is produced, a byproduct remains that needs to be removed from the system and eventually recycled.

A difficulty resides in extracting the hydrogen continuously from such components while removing the byproducts, especially when the byproducts are solid. Patent application WO2012151582 discloses a hydrogen generation system based on solid hydrogen carriers, capable of removing solid byproducts.

Patent application WO2020187754 discloses a system for continuous processing of heavy fuel oil comprising a substantially horizontal heated rotating reactor, a number of nozzles configured to distribute the oil evenly along the longitudinal direction within the reactor, and scraper means configured to maintain the thickness of the solid coke forming on the inner wall of the reactor at a given thickness. The nozzles are distributed such that the spray patterns do not overlap.

### SUMMARY

A device is generally provided for controlled production of a gas from first and second liquid reagents that, when mixed, produce the gas and a non-gaseous byproduct, the device comprising a reactor surface having a substantially vertical revolution axis; a shaft centered on the revolution axis and rotating relative to the reactor surface; two nozzles attached to the shaft, configured to spray the first and second reagents respectively on the reactor surface, wherein the two nozzles are tilted toward each other so that the first and second reagents are sprayed with intersecting cones on a common area of the reactor surface; and a scraper attached to the shaft, configured to separate the byproduct from the reactor surface while following the nozzles at a distance sufficient to let the reagents react.

The reactor surface may have an inversed truncated cone configuration.

The inversed truncated cone may have an angle at the vertex between 30 and 120 degrees

A leading edge of the scraper may contact the reactor surface with an angle of at most 90 degrees between the scraper and the reactor surface.

The device may further comprise a byproduct collection area, wherein the scraper and the reactor surface are oriented such that the separated byproduct falls into the collection area.

The scraper may lag the nozzles by an angle of at least 270 degrees.

The first reagent may be a liquid hydrogen carrier and the second reagent a liquid proton source, whereby the produced gas is hydrogen.

The hydrogen carrier may be a liquid silylated derivative.

The hydrogen carrier may alternatively be a liquid dihydrogen-polysiloxane, producing a byproduct essentially comprised of silicate.

A method is also provided for controlled production of a gas from first and second liquid reagents that, when mixed, produce the gas and a non-gaseous byproduct, the method comprising the following steps: spraying the first and second reagents along intersecting cones on a common area of a reactor surface having a substantially vertical revolution axis; and scraping the reactor surface to evacuate byproduct left on the reactor surface. The spraying and scraping are performed in a rotating motion around the revolution axis with a delay sufficient to let the reagents react.

### BRIEF DESCRIPTION OF THE DRAWINGS

Embodiments will be exposed in the following description provided for exemplary purposes only, in relation to the appended drawings, in which:

FIGS. 1A to 1C respectively illustrate three phases of a principle of operation of a device for producing gas from two liquid reagents.

FIGS. 2A to 2C respectively illustrate three operation phases of a practical embodiment of a device for producing gas from two liquid reagents.

FIG. 3 illustrates a perspective view of the device in operation in the phase of FIG. 2C.

### DETAILED DESCRIPTION

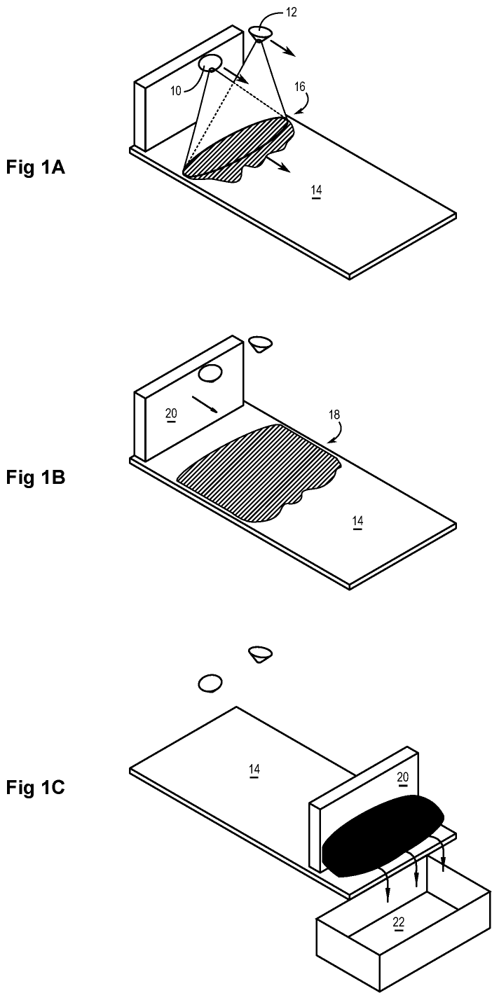

FIGS. 1A-1C are diagrams that illustrate a principle of operation of embodiments of a device for producing hydrogen from the reaction of two reagents that are both provided in liquid form. A byproduct removal mechanism is illustrated that can be configured for processing a solid byproduct in a continuous hydrogen production cycle.

In FIG. 1A, the two liquid reagents, for instance a hydrogen carrier and a proton source are sprayed by respective nozzles 10, 12 on a reactor surface 14. Since the two reagents should be mixed together to the best possible extent, the nozzles are preferably oriented such that the two reagents are sprayed on a common area 16 of the reactor surface, which may be obtained by tilting the nozzles towards each other, as shown.

With such a configuration, the spraying cones intersect, as shown by dotted lines, and mixing of the reagents starts before they reach the surface. To increase efficiency, the intersection volume of the spraying cones is made as large as possible, which may be obtained by fixing the nozzles as close as possible to each other.

In addition, the nozzles 10, 12 are configured to move together along the reactor surface 14 as they spray the reagents, as shown by arrows, thus depositing a uniform film of liquid reagents on the surface. The speed of motion and the flow rates of the nozzles are adjusted as a function of the reaction time and the desired gas production rate.

In FIG. 1B, the nozzles have swept a certain extent of the reactor surface, depositing a film of reagents. The deposited reagents have reacted leaving a solid byproduct 18.

A scraper 20 is then set in motion from behind the position of the nozzles, as illustrated by an arrow. The scraper is configured to sweep the whole extent of the reactor surface where the reagents were deposited and evacuate the remaining solid byproduct.

In FIG. 1C, the scraper 20 reaches the opposite end of the reactor surface. The solid byproducts are pushed over the edge of the surface and fall into a temporary storage area, such as a collection tray 22 placed below the edge of the reactor surface.

After this phase, the scraper and nozzles are returned to the position of FIG. 1A to start a new cycle.

The reactor surface 14 may be made in any material withstanding the reaction temperature and mechanical stress. Preferably the material does not adhere to the byproduct and allows easy removal of the byproduct. The surface may further be coated with a catalyst promoting the reaction.

The device of FIGS. 1A-1C has been shown to illustrate a principle of operation. It does not as such allow a continuous production of gas, because it requires a reset phase to start a new production cycle.

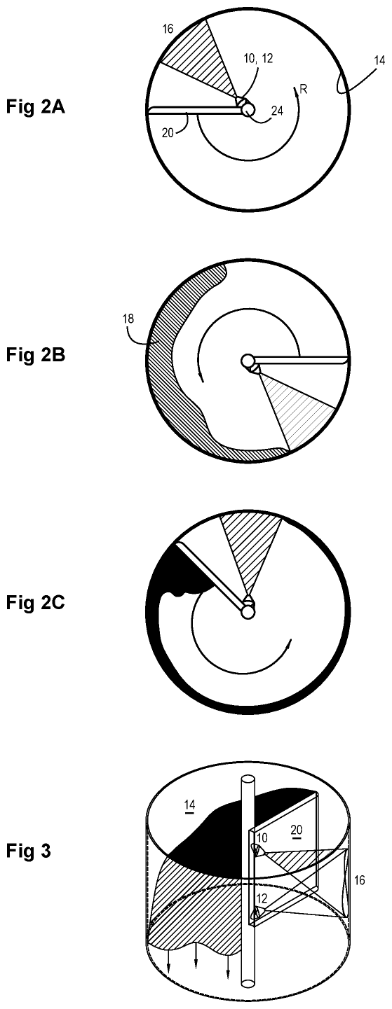

FIGS. 2A-2C illustrate three operation phases of a practical embodiment of a device that continuously produces gas from two liquid reagents, using the principle illustrated in FIGS. 1A-1C.

In FIG. 2A, the reactor surface 14 is in the form of a revolution surface, such as a cylinder. A shaft 24 is configured to rotate about the revolution axis of the cylinder 14, and bears the nozzles 10, 12 and the scraper 20. In other words, the nozzles and the scraper all rotate synchronously, for instance anti-clockwise on FIGS. 2A-2C, as illustrated by an arrow R.

The nozzles 10, 12 are aligned axially on the shaft 24 and oriented to spray the liquid reagents radially on a common target area 16 of the internal cylinder surface 14. The scraper 20 is configured to sweep the internal cylinder surface as the shaft rotates and has a height in contact with the cylinder surface preferably greater than that of the common target spraying area.

In order to increase the reaction time for a given rotation speed, the scraper 20 is mounted on the shaft such that it starts operating as late as possible after the initial spraying. Ideally the scraper operates with a rotation lag of 360 degrees after the nozzles, which would mean that the scraper is aligned with the nozzles on the shaft. This is not feasible in practice. As shown as a practical example, the scraper 20 is mounted on the shaft such that it leads the nozzles by approximately 45 degrees in the direction of rotation, leaving some clearance for the spraying cones. Such a configuration corresponds to a scraping operation lag of approximately 315 degrees. Satisfactory results may be obtained within a range of lag angles, for instance between 270 and 360 degrees.

As shown, the leading edge of the scraper contacts the cylinder surface with an angle of approximately 90 degrees. The leading edge preferably has a penetrating profile, i.e. having an angle between the scraper and the cleaned surface no larger than 90 degrees, so that the scraper, preferably made of a compliant material, maintains a scraping effect as opposed to a laminating effect. The trailing edge of the scraper may be tapered, as shown.

In FIG. 2A, an initial phase is shown, where the cylinder 14 is clean and the nozzles 10,12 only just start spraying the reagents, and no byproduct has formed.

In FIG. 2B, the nozzles and scraper have rotated by 180 degrees. The nozzles have deposited a uniform layer of reagents on half the cylinder. The deposited reagents start reacting, leaving a solid byproduct layer 18 that normally grows thicker with time. The scraper 20 has not yet started operating.

In FIG. 2C, the scraper 20 reaches the point where the nozzles started spraying in FIG. 1A. Here the scraper reaches the first byproduct formation and starts removing it.

FIG. 3 illustrates a perspective view of the device in operation in the phase of FIG. 2C. Various constructional details of the elements are better visible. As mentioned before, the nozzles 10, 12 are tilted towards each other so that they both spray a same common area 16 of the cylinder, and that their spraying cones intersect. The scraper 20 may have a generally parallelepipedal shape.

The cylinder 14 is preferably vertical, so that the detached byproduct falls by gravity into a lower portion of the cylinder serving as a storage area. The scraper may be configured so that its contact edge with the cylinder surface is tilted to exert a downwards push on the deposited byproduct.

The bottom of the cylinder may be equipped with an airtight drawer system for regularly removing the excess byproduct during a gas production cycle. Once the drawer is full, it contains little or no gas, whereby its removal will cause very little gas leakage. Alternatively, the bottom of the cylinder may be sufficiently large for storing all of the byproduct of a production cycle.

Such a system achieves production of gas from liquid reagents in a continuous mode. The gas production rate of the system increases with the flow rates of the nozzles. With an increasing flow rate, the rotation speed of the system should be increased, but the rotation speed is capped by the reaction time of the reagents, whereby the diameter and height of the cylinder may be increased.

In some situations, especially at higher flow rates with low-viscosity reagents, the vertical cylinder configuration may cause the reagents to flow downwards and drip off the cylinder surface before they finish reacting together.

To prevent this, the reactor surface may have an inversed truncated cone configuration (with the vertex and the truncated section at the bottom, the latter directed towards the collection area). The angle at the vertex of the cone is selected to prevent the reagents from flowing, or at least slow down the flowing to offer sufficient time for the reagents to react together.

Good results for hydrogen extraction applications were observed with an angle at the vertex of about 90 degrees. The smallest angle value depends on the flow rate of the nozzles and the viscosity of the reagents. In practice, this value may be around 30 degrees. The actual angle at the vertex may be selected anywhere above that value, the upper limit being 180 degrees (where the cone would be a disk). In practice, angles above 120 degrees will be avoided, because they would hinder the extraction of the byproduct and make the device too cumbersome, and angles below 20 degrees will be avoided because they do not provide sufficient retention of the reagents.

Using a vertical axis cone is preferable over a tilted cylinder as disclosed in patent application WO2020/187754. Indeed, a vertical axis cone offers a uniformly tilted surface at any angular position, whereby uniform reaction conditions for the two sprayed reagents are offered throughout the sprayed area.

As previously mentioned, the hydrogen carrier reagent may be of the family of hydrogen-methyl-polysiloxanes, having the general formula (HRSiO)n, which are available in liquid form. The proton source reagent may simply be water, among other possibilities. The resulting byproduct is however difficult to recycle.

A preferred hydrogen carrier would be of the family of dihydrogen-polysiloxanes, having the general formula (H2SiO)n, because their byproduct essentially corresponds to silicate, which can be readily recycled back into a hydrogen carrier. Such a compound also reacts with water as a proton source, among other possibilities.

Dihydrogen-polysiloxanes have only been found in solid form and have been difficult to produce industrially. However, patent application EP18305549 discloses a method for producing dihydrogen-polysiloxanes industrially in liquid form, which makes them particularly well suited for use in the present system.

The system disclosed herein is applicable to the production of gas from any liquid reagents that leave a solid byproduct. Although the device has been specifically designed to process solid byproducts, it may also be used to process a liquid byproduct in a very similar manner.

The spraying nozzles 10, 12 have been disclosed as a preferred embodiment for spreading the liquid reagents on the reactor surface. More generally, the liquid spreading may be achieved by alternative techniques such as a blade that spreads the liquids, or a brush equipped with a liquid dispenser, or a dome-shaped liquid deflector to create a falling liquid layer.

1. A device for controlled production of a gas from first and second liquid reagents that, when mixed, produce the gas and a non-gaseous byproduct, the device comprising:
a reactor surface having a substantially vertical revolution axis;
a shaft centered on the revolution axis and rotating relative to the reactor surface;
two nozzles attached to the shaft, configured to spray the first and second reagents respectively on the reactor surface, wherein the two nozzles are tilted toward each other so that the first and second reagents are sprayed with intersecting cones on a common area of the reactor surface; and
a scraper attached to the shaft, configured to separate the byproduct from the reactor surface while following the nozzles at a distance sufficient to let the first and second reagents react.

2. The device of claim 1, wherein the reactor surface has an inversed truncated cone configuration.

3. The device of claim 2, wherein the inversed truncated cone has an angle at the vertex between 30 and 120 degrees.

4. The device of claim 1, wherein a leading edge of the scraper contacts the reactor surface with an angle of at most 90 degrees between the scraper and the reactor surface.

5. The device of claim 1, comprising a byproduct collection area, wherein the scraper and the reactor surface are oriented such that the separated byproduct falls into the collection area.

6. The device of claim 1, wherein the scraper lags the nozzles by an angle of at least 270 degrees.

7. The device of claim 1, wherein the first reagent is a liquid hydrogen carrier and the second reagent is a liquid proton source, whereby the produced gas is hydrogen.

8. The device of claim 7, wherein the hydrogen carrier is a liquid silylated derivative.

9. The device of claim 7, wherein the hydrogen carrier is a liquid dihydrogen-polysiloxane, producing a byproduct essentially comprised of silicate.

10. A method for controlled production of a gas from first and second liquid reagents that, when mixed, produce the gas and a non-gaseous byproduct, the method comprising the following steps:
spraying the first and second reagents along intersecting cones on a common area of a reactor surface having a substantially vertical revolution axis; and
scraping the reactor surface to evacuate byproduct left on the reactor surface;
wherein the spraying and scraping are performed in a rotating motion around the revolution axis with a delay sufficient to let the first and second reagents react.

11. The method of claim 10, wherein the reactor surface has an inversed truncated cone configuration.

12. The method of claim 11, wherein the inversed truncated cone has an angle at the vertex between 30 and 120 degrees.

13. The method of claim 10, wherein the scraping lags the spraying by an angle of at least 270 degrees.

14. The method of claim 10, wherein the first reagent is a liquid hydrogen carrier and the second reagent is a liquid proton source, whereby the produced gas is hydrogen.

15. The method of claim 14, wherein the hydrogen carrier is a liquid dihydrogen-polysiloxane, producing a byproduct essentially comprised of silicate.
